(19) United States
(12) Patent Application Publication
(10) Pub. No.: US 2013/0001212 A1
(43) Pub. Date: Jan. 3, 2013

(54) ELECTRICAL HEATING JACKET

(76) Inventor: Daniel R. Mangoubi, Newton, MA (US)

(21) Appl. No.: 13/172,053

(22) Filed: Jun. 29, 2011

(51) Int. Cl. H05B 3/00

(52) U.S. Cl. 219/211

(57) ABSTRACT

A heated thermal garment for providing temperature control for a wearer is disclosed. The garment comprises a water-resistant exterior shell; a thermally-insulating interior lining; a microcontroller disposed between the interior lining and the exterior shell; a network of temperature sensors disposed between the interior lining and the exterior shell and in communication with the microcontroller; a network of heating elements disposed between the interior lining and the exterior shell, and a battery assembly providing power to the microcontroller and to the network of heating elements. Temperature zones are provided by monitoring a plurality of temperatures of an interior of the garment.

### TECHNICAL FIELD

The present invention pertains to a heated garment. More particularly, the present invention pertains to a heated garment with electronic temperature control.

### BACKGROUND

It is well-known that protective and warm clothing is required during seasons that have cold temperatures. Indeed, there are many different varieties, types and choices for winter clothing, ranging from the practical to the fashionable, and from general-purpose winter gear to technical gear suitable for alpine climbing and sub-arctic temperatures. As this multiplicity of options suggests, there are as many different needs as there are individuals.

The present invention seeks to exceed the performance of regular winter clothing by actively generating heat. Garments with heating means are also well-known in the art. Such garments contain a heating element, typically electrical or chemical, along with batteries if needed. An example of such a garment is disclosed in U.S. Pat. No. 6.049,062.

However, the wearer of a typical heated garment often experiences discomfort as a result of heating elements in the prior art. This may occur, for instance, when the heating element is unable to evenly distribute heat throughout the garment, and causes one area near the skin to be heated while not heating other areas, such that the wearer experiences extreme heat in one area. This may also occur when the heating element is properly employed and warms the wearer, but the wearer becomes too warm unless the heating element is manually turned off by the wearer. This may also occur when the heating element does not provide heat to certain areas of the body, such as the hands, arms and extremities, that the wearer may often find to be cold. Existing heated garments with temperature control do not fully alleviate these problems.

Therefore, it can be appreciated that there exists a continuing need for new and improved heated garments that provide temperature control in a manner that provides for an appropriate amount of heat in appropriate areas of the body so as to provide the wearer with comfort and warmth.

### SUMMARY OF THE INVENTION

A wearable garment relating to a heated thermal garment for providing temperature control for a wearer are disclosed. The garment comprises a water-resistant exterior shell; a thermally-insulating interior lining; a microcontroller for providing temperature zones by monitoring a plurality of temperatures of an interior of the garment; a network of temperature sensors disposed between the interior lining and the exterior shell and in communication with the microcontroller; a network of heating elements disposed between the interior lining and the exterior shell, and a battery assembly providing power to the microcontroller and to the network of heating elements. The network of heating elements is distributed over a plurality of areas of the thermal garment, is for providing appropriate amounts of heat to each of the plurality of areas, and is in communication with the microcontroller such that the microcontroller provides independent activation of heating elements. The microcontroller is operable to regulate the temperature of the wearer by activating and deactivating heating elements based on a temperature reading from a temperature sensor proximate to the heating element.

### BRIEF DESCRIPTION OF THE DRAWINGS

FIG. 1 is a front view of a heated garment together with a temperature control circuit and heating circuitry in accordance with certain embodiments.

FIG. 2 is a wiring schematic of the temperature control circuit and heating circuitry in accordance with certain embodiments.

### DETAILED DESCRIPTION

### Garment Construction

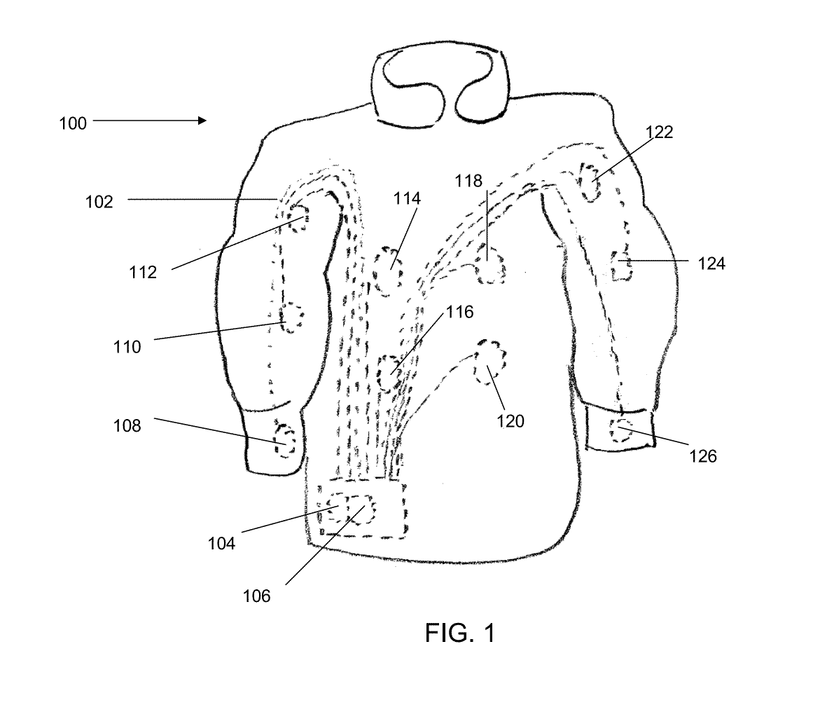

FIG. 1 depicts a garment 100 with an integrated heating system 102, including batteries 104 and a microcontroller 106. A typical cold-weather jacket may be used for the garment itself in some embodiments, where the jacket can be made of a waterproof shell and an insulating filler material. Nylon or polyester, or another waterproof and light synthetic fabric, may be used for the shell. The batteries and microcontroller may be contained within a battery pack and a microcontroller package, which in turn may be contained within a neoprene or nylon pouch in some embodiments, which is connected to the interior of the jacket. The pouch may be removed in some embodiments to allow the garment to be washed. As shown in FIG. 1, the pouch is positioned at the front of the jacket near the waist in some embodiments. This position may allow the wearer to operate the controls of the device with his or her hands inside a pocket of the jacket or inside the shell of the jacket. The pocket may have a Velcro closure, or another type of closure.

In some embodiments, four to six standard D-cell batteries may be used to power the heating elements and a microcontroller. The batteries may be enclosed in a battery pack, and the microcontroller package may provide a switch or button that allows the heating circuit to be turned on or off. Other batteries, including rechargeable batteries, NiCd batteries, or lithium-ion batteries, may be used. Additional battery packs may also be interchangeably provided, so that the garment may be continuously operated for a longer period of time.

The microcontroller may be a standard microcontroller, such as an Atmel AVR ATmega168 microcontroller, or another microcontroller. The microcontroller is programmed to interoperate with temperature sensors and to provide zone temperature control functionality. The chosen microcontroller is a low-power, 8-bit reduced instruction set computing (RISC) processor that comprises 16 KB flash memory, 1 KB static random-access memory (SRAM), 512 bytes of electrically erasable programmable read-only memory (EEPROM), and an analog-to-digital converter. The microcontroller is programmed to carry out the thermostat functionality described below, as well as a timed auto-shutoff function, intended to prevent a user from inadvertently draining the batteries or causing the garment to catch fire.

In some embodiments, the wires and temperature sensors are embedded within the jacket, between the inner lining and outer shell of the jacket. In some embodiments, a fire-retardant filler may be used. All the wires are connected to the microcontroller and battery, and may be connected at a single point via a connector in some embodiments. This facilitates the disconnection of the microcontroller and battery for washing of the garment.

Controls for adjusting the desired temperature may also be provided. A simple dial or buttons allowing the wearer to adjust a single desired temperature may be used. In some embodiments, three heating power settings may be provided, allowing the user to turn the heating element off, to use a target temperature, or to run the heating elements at maximum power in especially cold environments.

### Temperature Sensors and Heating Elements

FIG. 1 also shows a plurality of temperature sensors 108, 110, 112, 114, 116, 118, 120, 122, 124, 126. These temperature sensors are allocated to create temperature zones that cover different parts of the body. Each temperature sensor is connected to the processor via insulated copper signaling wires. Standard inexpensive thermistors may be used for the temperature sensors, such as the Omega HSTH-44000 series hermetically sealed thermistor sensor, available from Omega Engineering, Inc. The temperature sensors provide temperature sensing for temperatures in a range of values around the temperature of the human body.

The temperature sensors are positioned inside the garment to measure the temperature of the air within the garment. This allows the garment to shut off heating when the desired temperature inside the jacket is reached, without regard for the temperature outside the jacket. As well, in the case that the body temperature of the wearer is low in certain extremities, measuring internal air temperature will not cause the garment to overheat the garment to compensate, but instead will allow the garment to provide constant heating at a safe level that will not cause discomfort to the wearer. Alternatively, outside air temperature and the wearer's skin temperature may also be used separately or in combination to provide a combination of these benefits. For example, using the skin temperature of the wearer can provide relief to a wearer whose hands are cold due to poor circulation, even when the air temperature is the same throughout the interior of the garment.

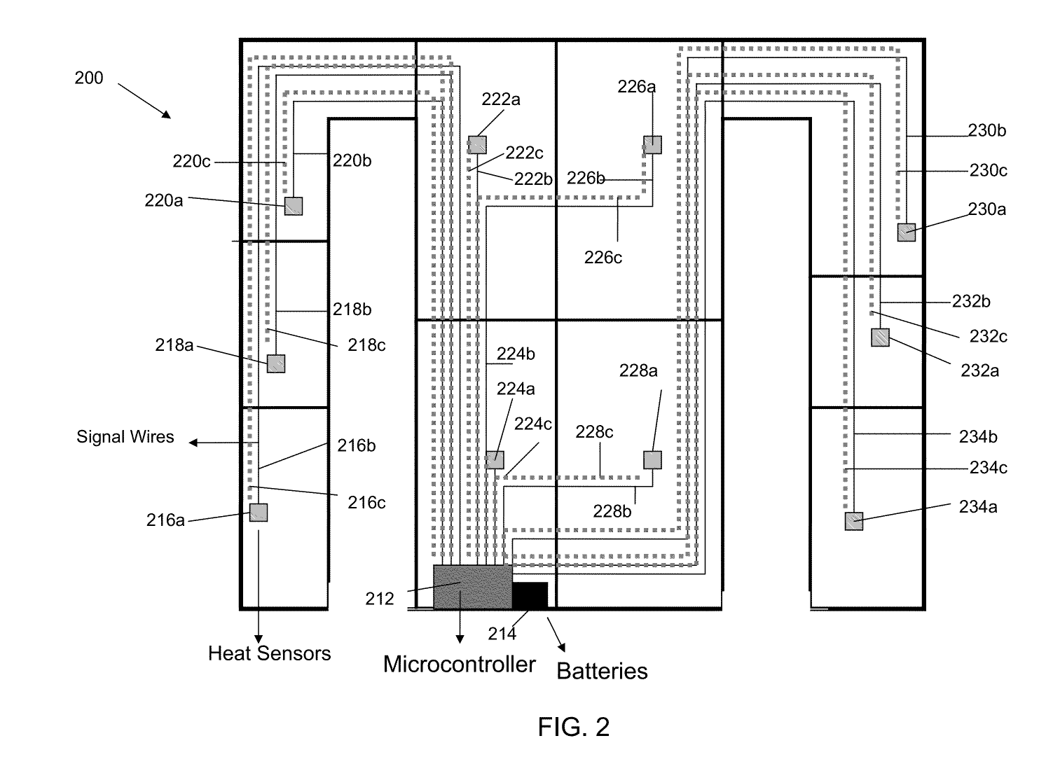

FIG. 2 shows the temperature sensors arranged in temperature zones, roughly corresponding to parts of the upper body. Although shown with four zones corresponding to different quadrants of the torso, temperature zones could be separated into front and back or into other arrangements. Garment 200 contains microcontroller 212 and batteries 214, and temperature sensors 216a, 218a, 220a, 222a, 224a, 226a, 228a, 230a, 232a, and 234a and signal wires 216b, 218b, 220b, 222b, 224b, 226b, 228b, 230b, 232b, and 234b. Microcontroller 212 is connected to each temperature sensor by a signal wire. The signal wires are insulated copper wires intended to be flexible and to conform to the wearer's body shape. Heating elements 216c, 218c, 220c, 222c, 224c, 226c, 228c, 230c, 232c, and 234c, which may be carbon fiber wires, are also directed to each temperature zone so that each zone can be independently heated based on the reading of the temperature sensor in that temperature zone. The temperature sensors and associated signal wires, and the heating elements, together make up the temperature zones. One or more carbon fiber wires may be used as a heating element in a particular temperature zone, and these carbon fiber wires may be arranged in a circular fashion around the limbs and extremities in some embodiments. These carbon fiber wires are also connected to the power supply.

In some embodiments, the temperature zones are placed in an arrangement corresponding to FIGS. 1 and 2. Specifically, three temperature zones are designated for each arm of the garment, and four temperature zones are designated for a torso portion of the garment. The selection of these zones allows for temperature to be independently controlled for the extremities and for the wearer's core temperature. Different temperature zones may be assigned for different garment types.

The heating elements may also be individually connected to the batteries via a switching arrangement controlled by the microcontroller. When the temperature reading in a temperature zone drops below a set level, the switching arrangement allows electrical current to flow through the heating element in the same temperature zone, which causes the heating element to heat the garment in the temperature zone. The set level is controlled by the wearer using a dial or buttons positioned on the exterior of the microcontroller package. A single temperature setting may be used, in some embodiments, to manage the temperature of all temperature zones. This can be sufficient to provide temperature control, as it is possible to provide warmth to cold areas of the body by heating only the specific temperature zones that are below the single temperature setting. In some embodiments, the temperature readings from multiple zones may be used to control a heating element in one (or more) of those zones, or the temperature reading from one zone may be used to control (in conjunction with other temperature readings) the heating elements in other zones.

Each temperature zone provides its own temperature feedback loop. The thermistor in a particular temperature zone provides the temperature reading that is used by the microprocessor for determining how much to heat the heating element in that temperature zone. However, in order to stabilize the feedback loop, the temperature reading is performed, in some embodiments, every two minutes. Allowing for a delay period allows the heating element to adequately heat the temperature zone before a new temperature reading is performed. These temperature zones allow the user to remain comfortable even given uneven body temperature and different degrees of heat loss in different parts of the garment.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims that follow. For example, while a single temperature setting is described, an arbitrary number of temperature settings could be used. Further, while an example of a jacket has been shown, other garments could be used.

We claim:

1. A heated thermal garment for providing temperature control for a wearer, the garment comprising:
a water-resistant exterior shell;
a thermally-insulating interior lining;
a microcontroller for providing temperature zones by monitoring a plurality of temperatures of an interior of the garment;
a network of temperature sensors disposed between the interior lining and the exterior shell and in communication with the microcontroller;
a network of heating elements disposed between the interior lining and the exterior shell, the network of heating elements distributed over a plurality of areas of the thermal garment, for providing heat to each of the plurality of areas, and in communication with the microcontroller such that the microcontroller provides independent activation of each heating element in the network of heating elements,
wherein the microcontroller is operable to activate and deactivate each heating element of the network of heating elements based on a temperature reading from a temperature sensor proximate to the heating element.

2. The garment of claim 1, further comprising an input device for setting a target temperature.

3. The garment of claim 1, further comprising the microcontroller providing temperature zones corresponding to a plurality of parts of the wearer's body.

4. The garment of claim 1, further comprising the microcontroller enabling an auto-shutoff function, wherein each of the heating elements are turned off after a set time.

5. The garment of claim 2, wherein the input device is positioned in proximity to a pocket of the garment so as to facilitate operation of the input device from the pocket.

6. The garment of claim 1, further comprising the microcontroller enabling a maximum heat output function, wherein each of the heating elements are turned on.

7. The garment of claim 1, wherein the microcontroller is disposed between the outer shell and the inner lining of the garment.

8. The garment of claim 1, the heating elements further comprising one or more electrically conductive wires.

9. The garment of claim 8, the heating elements further comprising carbon fiber.

10. The garment of claim 1, further comprising the temperature sensors and the heating elements being logically grouped into a plurality of temperature zones.

11. The garment of claim 10, wherein the temperature zones are each capable of being individually managed by the microcontroller based on a temperature reading in each temperature zone.

12. The garment of claim 11, wherein the temperature zones are each capable of being individually managed by the microcontroller based on a plurality of temperature settings.
